(19) United States
(12) Patent Application Publication
(10) Pub. No.: US 2022/0408701 A1
(43) Pub. Date: Dec. 29, 2022

(54) AUTOMATED FEEDING SYSTEM FOR FISH

(71) Applicant: X Development LLC, Mountain View, CA (US)

(72) Inventors: Barnaby John James, Campbell, CA (US); Zhaoying Yao, Palo Alto, CA (US); Grace Taixi Brentano, Redwood City, CA (US); Laura Valentine Chrobak, Menlo Park, CA (US); Kira Kamilla Smiley, E. Palo Alto, CA (US)

(21) Appl. No.: 17/358,973

(22) Filed: Jun. 25, 2021

(51) Int. Cl. A01K 61/85; G06K 9/00; G06N 3/08

(52) U.S. Cl. CPC A01K 61/85; G06K 9/00362; G06N 3/08

(57) ABSTRACT

Methods, systems, and apparatus, including computer programs encoded on computer-storage media, for the automated feeding of fish. In some implementations, a corresponding method may include obtaining meal configuration data including one or more parameters indicating a meal plan for feeding farmed fish; executing the meal plan based on the meal configuration data; receiving sensor data from one or more sensors during execution of the meal plan; and adjusting the execution of the meal plan based on the sensor data from the one or more sensors.

### FIELD

This specification generally describes enhanced feeding systems for fish in aquaculture environments.

### BACKGROUND

Researchers and fish farm operators face several challenges when feeding fish. Providing more food than what is required for normal growth may result in food waste as well as a corresponding increase in food expenses. Alternatively, providing less food than what is required for normal growth may affect the health of farmed fish, and may reduce the quality of the final product.

A manual process of observing and adjusting feed provided to fish is often used to monitor feeding levels, but this approach requires workers to be on site to monitor fish pen activity. Such a manual process is often time-consuming, expensive, and has several limitations, such as when cameras used to monitor fish activity are not correctly positioned or when adverse weather conditions decrease the availability of human observers.

### SUMMARY

In general, innovative aspects of the subject matter described in this specification relate to the monitoring and imaging of fish and fish feed, for example in the context of aquaculture. In one example implementation, feeding sessions are defined by meal configuration data which specifies at least one value that is determined based on a sensed feeding condition. For example, a feeding rate, which is controlled by a blower of a feeding system, can be determined based on the depth that feed pellets are seen to be falling within the pen by a camera.

According to another example implementation of the subject matter, configuration data of a meal plan is used to control a feeding device for fish. Images of the fish obtained by a camera during feeding are analyzed to determine subsequent actions based on the configuration data. Researchers or fish farm operators may adjust parameters of the configuration data to adjust the feeding of fish. The parameter adjustments may be used to determine optimal feeding, including maximizing growth while minimizing food waste.

Advantageous implementations can include a submersible camera device that obtains images of fish and the surrounding environment. The submersible camera device may patrol a pen containing fish and capture images that may be processed by onboard computers or may be sent to a remote computer for processing. The submersible camera may capture images that may be used to determine, among other things, if fish are still feeding or if feed is falling below a threshold indicating that fish are likely done feeding.

Researchers or fish farm operators may adjust parameters of the configuration data iteratively in order to optimize the feeding process. By automating the feeding, unintentional changes to a specified meal plan caused by manual processes may be reduced. In this way, feeding may be more correlated with specific, configurable parameters of the configuration data enabling more accurate A/B testing as well as optimization.

One innovative aspect of the subject matter described in this specification is embodied in a method that includes obtaining meal configuration data including one or more parameters indicating a meal plan for feeding farmed fish; executing the meal plan based on the meal configuration data; receiving sensor data from one or more sensors during execution of the meal plan; and adjusting the execution of the meal plan based on the sensor data from the one or more sensors.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, executing the meal plan based on the meal configuration data includes: determining the one or more parameters of the meal configuration data; and sending a signal to a feeding mechanism indicating the one or more parameters of the meal configuration data.

In some implementations, the signal is configured to instruct the feeding mechanism how to feed the farmed fish based on the one or more parameters.

In some implementations, adjusting the execution of the meal plan based on the sensor data includes: processing the sensor data using one or more models to generate values associated with one or more determinations; comparing the values with one or more conditions indicated by the meal configuration data; and adjusting the execution of the meal plan based on the one or more conditions indicated by the meal configuration data being satisfied or not satisfied based on the one or more determinations.

In some implementations, the one or more models include a trained neural network model.

In some implementations, the meal configuration data includes a policy that prevents, based on the sensor data, feeding the fish more than a predetermined amount.

In some implementations, the predetermined amount is expressed as a percentage of biomass indicating the biomass of the farmed fish to be fed.

In some implementations, the biomass of the farmed fish is determined by one or more trained models configured to determine a biomass for each fish depicted in one or more visual images.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for the automated feeding of fish.

FIG. 2 is a flow diagram illustrating an example of a process for the automated feeding of fish.

FIG. 3 is a diagram showing an example of a system for executing a meal.

FIG. 4 is a diagram illustrating an example of a computing system used for the automated feeding of fish.

Like reference numbers and designations in the various drawings indicate like elements.

### DETAILED DESCRIPTION

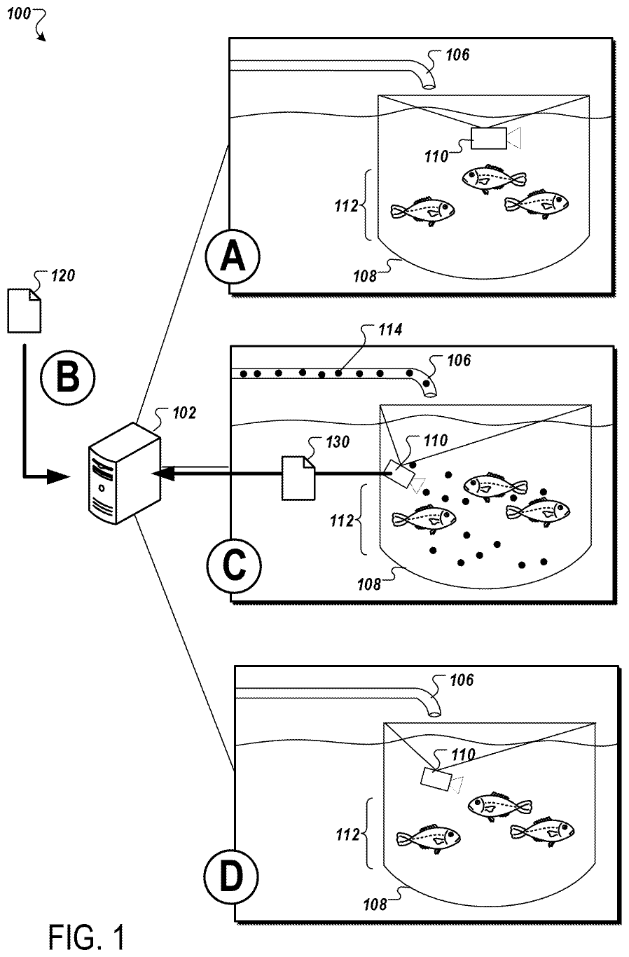

FIG. 1 is a diagram showing an example of a system 100 for the automated feeding of fish. The system 100 includes a control unit 102 configured to control a feeding mechanism 106 based on configuration data 120 and image data 130 collected by imaging device 110. The feeding mechanism 106 provides feed 114, such as fish pellets or other fish food, to fish 112 inside fish pen 108.

The imaging device 110 may be equipped with one or more cameras configured to capture visual images underwater. The imaging device 110 may also be equipped with one or more sensors to provide data to the control unit 102, such as a light sensor and a depth sensor. The imaging device 110 may be communicably connected to the control unit 102 in order to send the image data 130 to the control unit 102.

The feeding mechanism 106 can include a pipe connecting the pen 108 to a central feeding station that provides the feed 114 to the pen 108. In some implementations, a distributor located at the pen 108 may be used to more evenly distribute the feed 114 within the pen 108. For example, the distributor may move around the surface of the pen 108 while dropping the feed 114 for the fish 112. In some cases, a device may be used to propel the feed 114. For example, a blower that blows air or water with the feed 114 can be used to disperse the feed 114.

In stage A, the feeding mechanism 106 is not yet providing any feed. In stage B, the control unit 102 receives the configuration data 120. The configuration data 120 specifies meal parameters that may include an intensity at which to feed, a rate to increment the intensity of feeding from not feeding to feeding, a required depth of food after a given period of time, a required fraction of fish that are to be feeding, and a delay between the current meal plan execution and a subsequent meal plan execution. Other parameters may be specified in the configuration data 120 depending on implementation.

In stage C, the control unit 102 sends a signal to the feeding mechanism 106 to begin a meal based on the configuration data 120. The control unit 102 may send a signal to increment the feeding intensity of the feeding mechanism 106 based on an increment parameter specified in the configuration data 120. The increment parameter may determine the rate at which the feed 114 is progressively provided by the feeding mechanism 106 to the fish pen 108 from an initial feeding intensity specified in the configuration data 120 up to a maximum feeding intensity or until a determined condition is satisfied, such as feed depth.

Each of the initial feeding intensity, maximum feeding intensity, and maximum feed depth may be specified in the configuration data 120. The time between intensity increments may further be specified by the configuration data 120. For example, the feeding intensity may increase by 10 grams per second every minute.

The imaging device 110 sends the image data 130 to the control unit 102. In the example of FIG. 1, the image data 130 is a form of raw data and the control unit 102 processes the raw data in order to determine subsequent actions based on the meal plan in the configuration data 120. By performing processing at the control unit 102 instead of the imaging device 110, the system 100 may enable a lighter and cheaper imaging device 110 that need not be equipped with processing capabilities required for image analysis. Furthermore, the imaging device 110 may use energy that would have been required for image analysis to aid in other actions, such as movement, capturing images, sending images, among others.

In some implementations, the imaging device 110 may move around the pen 108 to obtain one or more images of the fish 112 and the surrounding environment. The imaging device 110 may be equipped with propellers, jets, or other propulsive means to travel within the water of the fish pen 108. The imaging device 110 may be attached to the pen 108 with rope or cable. Lengths of rope or cable used to connect the imaging device 110 to the pen 108 may be elongated or shortened in order to move the imaging device 110 around the pen 108. Instead of, or in addition to, a depth sensor, the length of rope may be monitored in order to determine the effective depth of the imaging device 110.

The control unit 102 receives the image data 130 from the imaging device 110. The image data 130 includes one or more events corresponding to the fish 112. For example, the image data 130 may include an image of a fish. The fish may be one of one or more fish referred to herein as the fish 112. The control unit 102 may analyze the image of the fish using one or more analysis techniques including machine-learning methods. The fish may be identified based on a trained detection model trained to identify fish. The fish may further be identified as currently eating or swimming with mouth open using the same or a different detection model trained to identify the open mouth of a fish.

In the example of FIG. 1, the image data 130 includes an image of one or more pellets of the feed 114. The control unit 102 may analyze the image of the feed 114 to identify the one or more pellets. The imaging device 110 may capture an image of the feed 114 dropping below a threshold specified in the configuration data 120. After processing, the control unit 102 can determine, based on the detected feed 114 below the threshold, to send a stop signal to the feeding mechanism 106.

The control unit 102 may determine the depth that the feed 114 drops to by processing the image data 130. For example, the image data 130 may include a depth measurement sent by the imaging device 110 indicating the current depth of the imaging device 110. The depth measurement may be determined using a depth sensor affixed to the imaging device 110. The image data 130 may further include a tilt angle indicating what direction the imaging device 110 is pointed. The control unit 102 may use one or more elements of the image data 130 to determine the actual depth of objects detected within images received from the imaging device 110. The control unit 102 may compare the actual depth of the objects to criteria specified in the configuration data 120.

In stage D, the control unit 102 determines, based at least on the feed 114 falling through to a depth specified in the configuration data 120, to send a stop signal to the feeding mechanism 106. The stop signal is configured to stop the feed 114 being provided to the fish 112 of the fish pen 108.

In some implementations, a depth range may be used to determine whether to increase or decrease feeding. For example, the configuration data 120 may specify a depth range of 5 meters (m) to 15 m. If the control unit 102 detects the feed 114 beyond 15 m, the control unit 102 may send a stop signal to the feeding mechanism 106 configured to stop providing the feed 114 to the fish 112. Similarly, in some implementations, if the control unit 102 does not detect the feed 114 below 5 m, the control unit 102 may send an increase feeding signal to the feeding mechanism 106 configured to increase feeding.

In some implementations, the control unit 102 may decrease feeding based on the depth at which the feed 114 is detected. For example, in a range of 5 m to 15 m, the control unit 102 may detect the feed 114 at 11 m. Based on a predetermined scale that assigns regions of the range to percent feeding reductions, the control unit 102 can determine that the feed 114 at 11 m corresponds to reducing feed by 10 percent and can send a signal to the feeding mechanism 106 configured to reduce feeding by 10 percent.

The control unit 102 may later detect the feed 114 at 12 m and, based on the predetermined scale, send a signal to the feeding mechanism 106 to reduce feeding by 25 percent. The percent reductions may increase until a stop depth. If the feed 114 is detected beyond the stop depth, feed is reduced by 100 percent and the meal is over. In general, any depth range may be used and regions incorporated within may be associated with any feeding reductions specified in the configuration data 120.

In some implementations, detecting the feed 114 may include detecting at least one pellet or item of food. For example, each item of the feed 114 may be detected to determine a depth of the feed. The deepest identified item may be used to determine the depth of the feed 114. In some implementations, depths of one or more items of the feed 114 may be averaged in order to determine the depth of the feed 114. For example, the control unit 102 may detect 5 pellets at depths of 5 m, 5 m, 5 m, 7 m, and 12 m. If averaging is used, the depth of the feed 114 based on the 5 detected pellets may be determined, by the control unit 102, to be 6.8 m.

In some implementations, other metrics are used to determine the depth of the feed 114. For example, each depth associated with each item of food detected may be compared with a reference depth, such as the maximum stop depth, to determine the error between the detected depths and the reference. The differences may be combined to produce a metric, such as a root-mean-square of the differences. The metric may be used to control the effect of outlier detections on the depth calculation for the feed 114.

In some implementations, clustering algorithms may be used to determine the depth of the feed 114. For example, the depth of each item of the feed 114 may be determined by the control unit 102 based on the image data 130. A clustering algorithm, such as k-means clustering, may then be used to cluster a first and a second portion. The first portion may be used to determine the depth of the feed 114 and the second portion may be excluded from the calculation as outliers.

In some implementations, other outlier detection methods may be used to exclude outliers from a depth of the feed 114 calculation. For example, the depth of each item of the feed 114 may be determined by the control unit 102 based on the image data 130. Using any number of outlier detection methods including z-score or extreme value analysis, probabilistic and statistical modeling, linear regression models, proximity based models, information theory models, and high dimensional outlier detection methods, the control unit 102 can determine one or more outliers to exclude in order to determine the depth of the feed 114.

In some implementations, the control unit 102 detects one or more other events based on the image data 130. For example, the control unit 102 may detect a fraction of total feeding. The fraction of total feeding may be determined based, in part, on determining the ratio of fish with open mouths to fish with closed mouths using one or more detection models as described herein. The fish with open mouths may be considered eating while the fish with closed mouths may be considered not eating. The control unit 102 may determine whether to increase feeding, decrease feeding, or stop feeding based, at least in part, on the fraction of total feeding and a goal fraction of total feeding specified in the configuration data 120.

In some implementations, the control unit 102 performs other actions in response to detecting one or more events in the image data 130. For example, the control unit 102 may determine that the feed 114 does not drop to a predetermined depth. This may be the result of the fish 112 near the surface of the pen 108 eating the food before it drops to the predetermined depth. The configuration data 120 may specify that the feed 114 drop to a predetermined depth in order to ensure enough food is provided to the fish 112. The control unit 102, using both the image data 130 and the configuration data 120, can send a signal to the feeding mechanism 106 that is configured to increase a feeding intensity in order to satisfy a depth of food requirement specified in the configuration data 120.

For another example, the control unit 102 may determine that the feed 114 drops below a predetermined depth. The configuration data 120 may specify that the feed 114 not drop to, or below, a predetermined depth. If the control unit 102 determines that the feed 114 satisfies a drop threshold, the control unit 102 can configure and send a signal to the feeding mechanism 106 to reduce the feed 114 or stop the feed 114 being provided to the fish 112.

In some implementations, the control unit 102 determines one or more values corresponding to one or more parameters of the configuration data 120 and, in response, determines a subsequent action based on the one or more values. For example, the control unit 102 can determine that the feeding rate of the fish pen 108 is lower than a predetermined threshold and that the feed drop depth is also lower than a predetermined threshold. The control unit 102 may then, based on the determined feed rate and determined feed drop depth compared to corresponding parameters in the configuration data 120, configure and send a signal to the feeding mechanism 106 to provide more feed.

In another example, the control unit 102 can determine that the feeding rate of the fish pen 108 is lower than a predetermined threshold and that the feed drop depth is higher than a predetermined threshold. This may be caused by the fish 112 being full and not eating and therefore the feed 114 dropping further. The control unit 102 may then, based on the determined feed rate and determined feed drop depth compared to corresponding parameters in the configuration data 120, configure and send a signal to the feeding mechanism 106 to reduce the feed 114 or stop the meal. In this way, a single value associated with a parameter of the configuration data 120 may be interpreted by the control unit 102 according to one or more other values determined by the control unit 102.

In some implementations, the imaging device 110 may pre-process images obtained by the imaging device 110. For example, the imaging device 110 may process obtained images and send corresponding processed data to the control unit 102. In this way, the imaging device 110 may reduce processing requirements of the control unit 102, reduce necessary bandwidth to communicate with the control unit 102, as well as reduce energy requirements for the control unit 102.

In some implementations, one or more additional imaging devices may be used to obtain images. For example, the imaging device 110 may represent any number of imaging devices that may be employed within the pen 108 to capture images.

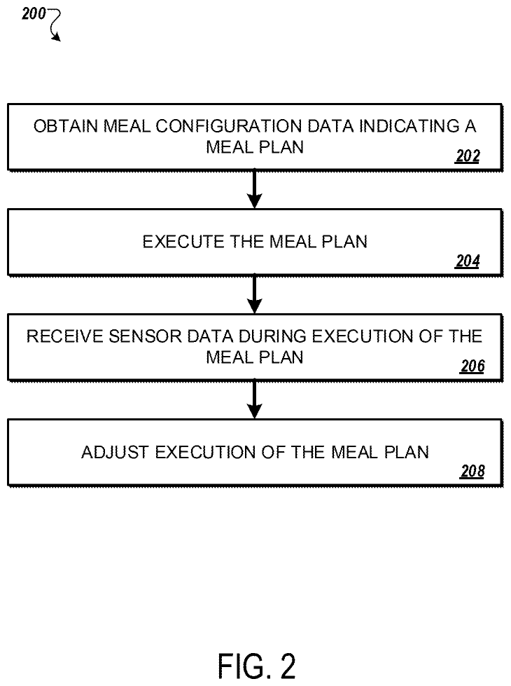

FIG. 2 is a flow diagram illustrating an example of a process 200 for the automated feeding of fish. The process 200 may be performed by one or more electronic systems, for example, the system 100 of FIG. 1.

The process 200 includes obtaining meal configuration data indicating a meal plan (202). For example, as shown in stage B of FIG. 1, the control unit 102 may receive the configuration data 120. Table 1 shows an example implementation of parameters and associated values that may be included in the configuration data 120.

TABLE 1

```
meal_config: {
  label: “MAIN_MEAL”
  initial_intensity_grams_per_sec: 150
  increment_intensity_grams_per_sec: 10
  time_between_intensity_increment_in_minutes: 1
  min_depth_in_m: 6
  fall_through_depth_in_m: 18
  fall_thru_score_threshold: 0.5
  feed_adjustment_proportional_gain: 0.25
  fraction_of_total_feeding: 0.8
  delay_to_next_meal_in_minutes: 60
}
```

In some implementations, the configuration data 120 may include one or more adjustable parameters. For example: the configuration data 120 may include an “initial_intensity_grams_per_sec” parameter that can control how much of the feed 114 is provided to the fish 112 at the beginning of a meal; the configuration data 120 may include an “increment_intensity_grams_per_sec” parameter that can control how much the rate at which the feed 114 is provided to the fish 112 is increased; the configuration data 120 may include a “time_between_intensity_increment_in_minutes” parameter that can control the rate at which the feed 114 is incremented by a determined increment value (e.g., Increment_intensity_grams_per_sec′); the configuration data 120 may include a “min_depth_in_m” parameter that can specify the minimum depth of the feed 114 or the minimum depth of a sensor, such as the imaging device 110; the configuration data 120 may include a “fall_through_depth_in_m” parameter that can specify the depth that the feed 114 may reach as it falls in the water, as sensed by a camera; the configuration data 120 may include a “fall_thru_score_threshold” that can control the amount of the feed 114 that falls through and prevent excess fall through, as sensed by the camera; the configuration data 120 may include a “feed_adjustment_proportional_gain” that can control the rate at which the feed 114 is adjusted when adjustments are required to satisfy parameters of the configuration data 120; the configuration data 120 may include a “fraction_of_total_feeding” that can specify the amount of fish of the fish 112 that should be feeding during a meal where a trained model may detect fish with mouths open as fish that are feeding and fish with mouths closed as fish that are not feeding; the configuration data 120 may include a “delay_to_next_meal_in_minutes” that can specify the amount of time between the current meal, such as the ‘Main Meal’ and a subsequent meal where the delay may be adjusted based on the amount of food provided to the fish.

The process 200 includes executing the meal plan (204). For example, the control unit 102 may send a signal to the feeding mechanism 106 to begin a meal based on the configuration data 120. The configuration data 120 may include an “initial_intensity_grams_per_sec” parameter indicating at what initial rate the feed 114 should be provided to the fish 112.

The process 200 includes receiving sensor data during execution of the meal plan (206). For example, the control unit 102 may use input from one or more sensors, such as the imaging device 110, to determine values of one or more parameters and then compare the values determined based on the sensor data to the obtained parameters in the configuration data 120.

The process 200 includes adjusting execution of the meal plan (208). For example, the control unit 102 can compare a value of “fall_through_depth_in_m” specified in the configuration data 120 to a determined feed depth. After determining that the feed has reached a depth deeper than the value of “fall_through_depth_in_m” specified in the configuration data 120, the control unit 102 can send a signal to the feeding mechanism 106 to decrease or stop feeding.

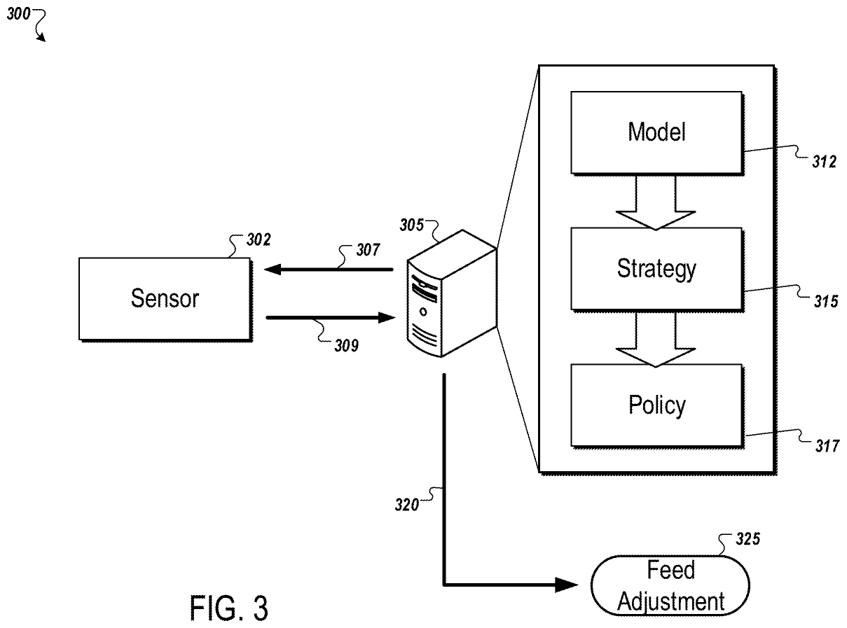

FIG. 3 is a diagram showing an example of a system 300 for executing a meal. The system 300 includes a sensor 302 that communicates with a control unit 305. The system 300 can be used to implement the techniques described herein. For example, the imaging device 110 could be an example of the sensor 302 and the control unit 102 could be an example of the control unit 305.

In some implementations, the sensor 302 may be attached to, or a part of, a moving device. For example, the sensor 302 may be a camera attached to a submersible patrol device configured to move underwater. The sensor 302 may be a light sensor, proximity sensor, or other electronic apparatus configured to collect data. The sensor 302 may include computer hardware configured to obtain and send data.

The control unit 305 may send a first communication 307 to the sensor 302. In some cases, the first communication 307 may include details of a patrol task. For example, the control unit 305 may send a signal instructing the sensor 302 to move to a specific area within a fish pen, such as the fish pen 108. The control unit 305 may send a signal instructing the sensor 302 to obtain data from a particular region, such as images from a particular depth or of a location within a fish pen.

In some implementations, the control unit 305 may control a type of movement for the sensor 302. For example, the control unit 305 may send a signal instructing the sensor 302 to move to a specific depth or may indicate allowable depths within which the sensor 302 may patrol. For another example, the control unit 305 may send a signal instructing the sensor 302 to move at a particular speed.

In some implementations, the control unit 305 may control what data is obtained by the sensor 302. For example, the control unit 305 may send a signal instructing the sensor 302 to capture visual images at a specific frequency for a particular amount of time. This may be configured to coincide with other events, such as feeding events where more image data may be useful to have.

In response to the first communication 307, the sensor 302 may send sensor data 309 to the control unit 305. The sensor data 309 may include visual images obtained by the sensor 302, such as the image data 130. The sensor data 309 may include other data forms as well depending on the first communication 307. For example, the sensor data 309 may include one or more determinations generated by the sensor 302 or a device communicably connected to the sensor 302.

In some implementations, the sensor data 309 may include other forms of data. For example, the sensor data 309 may include feedback from various feeding mechanisms, such as the feeding mechanism 106. The sensor data 309 may indicate the amount of feed currently being provided or other status information such as an operational status of a device to provide food to an area, such as the fish pen 108.

The control unit 305 may process the sensor data 309 based on data pre-obtained by the control unit 305. In some cases, the pre-obtained data may include the configuration data 120. The pre-obtained data in the system 300 includes a model 312, a strategy 315, and a policy 315. In some implementations, the configuration data 120 may include one or more elements of the model 312, the strategy 315, and the policy 315.

The model 312 processes the sensor data 309 to make one or more determinations based on the sensor data 309. For example, if the sensor data 309 includes an image of a fish, the model 312 may detect the occurrence of the fish within the sensor data 309. The model 312 may be a collection of one or more trained models configured to detect particular occurrences in the feeding scenarios discussed herein. For example, the model 312 may be used to detect occurrences of fish with mouths open or a number of pellets within one or more images of the sensor data 309.

In some implementations, the model 312 includes a biomass estimation. For example, one or more trained models of the model 312 may be configured to determine a biomass estimation for a fish based on one or more images of the fish. In some implementations, an untrained model is provided images of fish with associated biomasses. The untrained model may be trained by adjusting one or more of its parameters to generate output that matches the associated biomasses. In some cases, truss lengths between parts of a detected fish are used as input to a model for predicting biomass. For example, the processing techniques described in U.S. application Ser. No. 16/734,661, filed Jan. 6, 2020 and entitled “Fish Biomass, Shape, Size, or Health Determination”, which is incorporated herein by reference, may be used in processing by the control unit 305.

The output of the model 312 may be used to interpret conditions of the strategy 315 as well as the policy 317. For example, the model 312 may detect that a fish pen has been provided 3 percent of its collective biomass in feed. The strategy 315 may indicate, for example, based on feed drop depth, that feeding should continue. The policy 317 may include a max feed amount to stop feeding when necessary, such as when the total feed amount reaches a certain percentage, e.g., 3 percent, of a fish pen's biomass.

Even though the parameters of the strategy 315 may require additional feeding, if the max feed amount in the policy 317 is reached, the control unit 305 may send a signal to stop feeding. In this case, the policy 317 may be used to ensure that fish are not fed too much or too little. The policy 317 may include maximum and minimum feeding rates as well as maximum feeding amounts in weight and as a percentage of biomass.

Table 2 shows an example implementation of parameters and associated values that may be included in the policy 317. In some implementations, the policy 317 may be included in the configuration data 120.

TABLE 2

```
policy_config: {
  min_pen_feeding_rate_kg_per_min: 2
  max_pen_feeding_rate_kg_per_min: 40
  max_pen_feeding_amount_percent_biomass: 3
  pen_total_feed_hard_limit_in_kg: 8000
}
```

In some implementations, the policy 317 may include one or more adjustable parameters. For example: the policy 317 may include a “min_pen_feeding_rate_kg_per_min” that may prevent a given feeding strategy from reducing a feeding rate below a predetermined value specified by the parameter; the policy 317 may include a “max_pen_feeding_rate_kg_per_m in” that may prevent a given feeding strategy from increasing a feeding rate above a predetermined value specified by the parameter; the policy 317 may include a “max_pen_feeding_amount_percent_biomass” that may prevent a given feeding strategy from continuing to feed a group of fish an amount of feed more than a percentage of biomass specified by the parameter; the policy 317 may include a “pen_total_feed_hard_limit_in_kg” that may prevent a given feeding strategy from continuing to feed a group of fish an amount of feed more than an amount of feed specified by the parameter.

In some implementations, parameters of the strategy 312 and the policy 317 may be adjusted to change the automated feeding process. For example, as discussed herein with respect to the configuration data 120, elements of the control unit 305 including the model 312, the strategy 315, and the policy 317 may be pre-obtained by the control unit 305 in order to process the sensor data 309. Output of the model 312 may be used to determine whether one or more conditions in the strategy 315 are met. These conditions are discussed herein with respect to the configuration data 120. Before adjusting the meal, the control unit 305 may check one or more conditions of the policy 317.

In some implementations, the conditions of the policy 317 may be given higher priority than conditions of the strategy 315. For example, when, based on one or more determinations of the model 312, a condition of the strategy 315 would increase feeding and a condition of the policy 317 would stop feeding, the control unit 305 may give the policy 317 high priority by stopping the feeding instead of increasing feeding.

The control unit 305 may determine, based on one or more outputs of the model 312 and conditions of the strategy 315 and the policy 317 a feed adjustment 325. A feed adjustment signal 320 indicating the feed adjustment 325 may be sent to a relevant feeding mechanism configured to adjust the feed provided to fish, such as the fish within the fish pen 108.

In some implementations, the control unit 305 may determine that a maximum feed amount has been reached. For example, regardless of conditions within the strategy 315, a max feeding condition of the policy 317 may be satisfied. In this case, the control unit 305 may determine to stop feeding. The feed adjustment 325 may be configured to indicate that feeding should be stopped and a corresponding feed adjustment signal 320 may be sent to a feeding mechanism.

In some implementations, the control unit 305 may determine one or more conditions of the strategy 315 or the policy 317 without processing data in the model 312. For example, an amount of feed provided to fish may be sent by the sensor 302 and compared with a condition in the policy 317 without further processing by the model 312. The sensor 302 in this case may include a sensor fixed to a feeding mechanism, such as the feeding mechanism 106, configured to measure the feed being provided to fish. As previously mentioned, although depicted as a singular sensor for illustration purposes, the sensor 302 may include more than one sensor configured to obtain data.

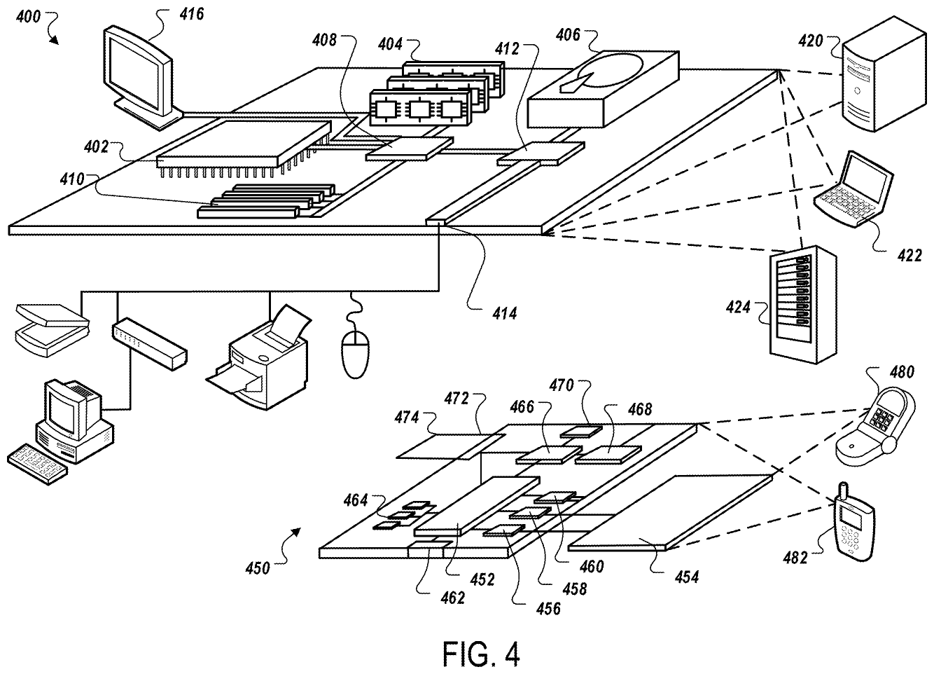

FIG. 4 is a diagram illustrating an example of a computing system used for the automated feeding of fish. The computing system includes computing device 400 and a mobile computing device 450 that can be used to implement the techniques described herein. For example, one or more components of the system 100 or the system 300 could be an example of the computing device 400 or the mobile computing device 450, such as a computer system implementing the control unit 102, the feeding mechanism 106, the imaging device 110, the control unit 305, or the sensor 302.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 5G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and

CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims can be performed in a different order and still achieve desirable results.

What is claimed is:

1. A computer-implemented method comprising:
obtaining meal configuration data including one or more parameters indicating a meal plan for feeding farmed fish;
executing the meal plan based on the meal configuration data;
receiving sensor data from one or more sensors during execution of the meal plan; and
adjusting the execution of the meal plan based on the sensor data from the one or more sensors.

2. The method of claim 1, wherein executing the meal plan based on the meal configuration data comprises:
determining the one or more parameters of the meal configuration data; and
sending a signal to a feeding mechanism indicating the one or more parameters of the meal configuration data.

3. The method of claim 2, wherein the signal is configured to instruct the feeding mechanism how to feed the farmed fish based on the one or more parameters.

4. The method of claim 1, wherein adjusting the execution of the meal plan based on the sensor data comprises:
processing the sensor data using one or more models to generate values associated with one or more determinations;
comparing the values with one or more conditions indicated by the meal configuration data; and
adjusting the execution of the meal plan based on the one or more conditions indicated by the meal configuration data being satisfied or not satisfied based on the one or more determinations.

5. The method of claim 4, wherein the one or more models include a trained neural network model.

6. The method of claim 1, wherein the meal configuration data includes a policy that prevents, based on the sensor data, feeding the fish more than a predetermined amount.

7. The method of claim 6, wherein the predetermined amount is expressed as a percentage of biomass indicating the biomass of the farmed fish to be fed.

8. The method of claim 7, wherein the biomass of the farmed fish is determined by one or more trained models configured to determine a biomass for each fish depicted in one or more visual images.

9. A non-transitory, computer-readable medium storing one or more instructions executable by a computer system to perform operations comprising:
obtaining meal configuration data including one or more parameters indicating a meal plan for feeding farmed fish;
executing the meal plan based on the meal configuration data;
receiving sensor data from one or more sensors during execution of the meal plan; and
adjusting the execution of the meal plan based on the sensor data from the one or more sensors.

10. The medium of claim 9, wherein executing the meal plan based on the meal configuration data comprises:
determining the one or more parameters of the meal configuration data; and
sending a signal to a feeding mechanism indicating the one or more parameters of the meal configuration data.

11. The medium of claim 10, wherein the signal is configured to instruct the feeding mechanism how to feed the farmed fish based on the one or more parameters.

12. The medium of claim 9, wherein adjusting the execution of the meal plan based on the sensor data comprises:
processing the sensor data using one or more models to generate values associated with one or more determinations;
comparing the values with one or more conditions indicated by the meal configuration data; and
adjusting the execution of the meal plan based on the one or more conditions indicated by the meal configuration data being satisfied or not satisfied based on the one or more determinations.

13. The medium of claim 12, wherein the one or more models include a trained neural network model.

14. The medium of claim 9, wherein the meal configuration data includes a policy that prevents, based on the sensor data, feeding the fish more than a predetermined amount.

15. The medium of claim 14, wherein the predetermined amount is expressed as a percentage of biomass indicating the biomass of the farmed fish to be fed.

16. The medium of claim 15, wherein the biomass of the farmed fish is determined by one or more trained models configured to determine a biomass for each fish depicted in one or more visual images.

17. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
obtaining meal configuration data including one or more parameters indicating a meal plan for feeding farmed fish;
executing the meal plan based on the meal configuration data;
receiving sensor data from one or more sensors during execution of the meal plan; and
adjusting the execution of the meal plan based on the sensor data from the one or more sensors.

18. The system of claim 17, wherein executing the meal plan based on the meal configuration data comprises:
determining the one or more parameters of the meal configuration data; and
sending a signal to a feeding mechanism indicating the one or more parameters of the meal configuration data.

19. The system of claim 18, wherein the signal is configured to instruct the feeding mechanism how to feed the farmed fish based on the one or more parameters.

20. The system of claim 17, wherein adjusting the execution of the meal plan based on the sensor data comprises:
processing the sensor data using one or more models to generate values associated with one or more determinations;
comparing the values with one or more conditions indicated by the meal configuration data; and
adjusting the execution of the meal plan based on the one or more conditions indicated by the meal configuration data being satisfied or not satisfied based on the one or more determinations.
